(19) United States
(12) Patent Application Publication
(10) Pub. No.: US 2017/0274963 A1
(43) Pub. Date: Sep. 28, 2017

(54) DRIVE UNIT FOR BICYCLE

(71) Applicant: Shimano Inc., Sakai, Osaka (JP)

(72) Inventor: Takashi YAMAMOTO, Sakai, Osaka (JP)

(21) Appl. No.: 15/528,729

(22) PCT Filed: Dec. 24, 2015
(86) PCT No.: PCT/JP2015/085939

§ 371 Date: May 22, 2017

(30) Foreign Application Priority Data
Dec. 25, 2014 (JP) 2014-262351

(51) Int. Cl. B62M 11/14; F16H 3/72; B62L 5/00; B62M 6/55; B62M 6/90

(52) U.S. Cl. CPC B62M 11/145; B62M 6/55; B62M 6/90; B62L 5/006; F16H 3/727; B62M 2701/0092; F16H 2200/2082

(57) ABSTRACT

A bicycle drive unit includes a planetary gear mechanism, a first motor and a power switching mechanism. The planetary gear mechanism includes an input body, an output body and a transmitting body. The input body receives a rotational input of a crankshaft. The output body outputs the rotation of the planetary gear mechanism to the outside. The first motor controls the rotation of the transmitting body. The output body rotates in a direction corresponding to a first rotational direction when rotation in the first rotational direction is input from the crankshaft to the input body. The power switching mechanism rotates the output body in a direction corresponding to a second rotational direction when rotation in the second rotational direction is input from the crankshaft to the input body.

### CROSS-REFERENCE TO RELATED APPLICATIONS

This application is a U.S. National stage application of International Application No. PCT/JP2015/085939, filed on Dec. 24, 2015, which claims priority to Japanese Patent Application No. 2014-262351 filed on Dec. 25, 2014.

### BACKGROUND

Field of the invention

The present invention relates to a bicycle drive unit.

Background Information

Japanese Laid-Open Patent Publication No. 2008-285069 (Patent document 1) describes a bicycle drive unit of a continuously variable transmission type. In the bicycle drive unit, a motor controls rotation of components of a planetary gear mechanism. This transmits torque to the planetary gear mechanism and changes the transmission ratio of the planetary gear mechanism through continuously variable transmission.

The planetary gear mechanism of the bicycle drive unit includes a planetary carrier and a ring gear. Rotation inputted to the planetary carrier is outputted by the ring gear. A one-way clutch is located between a pedal crankshaft and the planetary carrier. The one-way clutch mechanically couples the pedal crankshaft and the planetary carrier to transmit rotation of the pedal crankshaft to the planetary carrier only in a state in which the pedal crankshaft is rotated in a forward rotation direction.

### SUMMARY

The one-way clutch does not transmit rotation of the pedal crankshaft to the planetary carrier in a state in which the pedal crankshaft is rotated in a direction opposite to the forward rotation direction. Thus, the bicycle drive unit of patent document 1 cannot perform coaster braking.

It is an object of the present invention to provide a bicycle drive unit that is configured to perform coaster braking. In one aspect of the present invention, a bicycle drive unit includes a planetary gear mechanism, a first motor, and a power switching mechanism. The planetary gear mechanism includes an input body to which rotation of a crankshaft is inputted, an output body that externally outputs rotation of the planetary gear mechanism, and a transmission body. The first motor controls rotation of the transmission body. In a case in which the crankshaft inputs rotation to the input body in a first rotation direction, the output body is rotated in a direction corresponding to the first rotation direction. In a case in which the crankshaft inputs rotation to the input body in a second rotation direction, the power switching mechanism rotates the output body in a direction corresponding to the second rotation direction.

In one example, in a case in which the crankshaft inputs rotation to the input body in the second rotation direction, the power switching mechanism connects the input body and the output body to integrally rotate the input body and the output body.

In one example, the input body is a ring gear, the output body is a carrier, and the transmission body is a sun gear. In one example, in a case in which the crankshaft inputs rotation to the ring gear in the first rotation direction and the carrier is rotated faster than the ring gear, the power switching mechanism allows for relative rotation of the ring gear and the carrier.

In one example, in a case in which the crankshaft inputs rotation to the ring gear in the first rotation direction, the power switching mechanism connects the ring gear and the carrier to integrally rotate the ring gear and the carrier until the carrier is rotated faster than the ring gear.

In one example, the power switching mechanism is at least partially located between the ring gear or the crankshaft and the carrier. In one example, the ring gear and the carrier include a portion where an inner circumference of the ring gear and an outer circumference of the carrier are opposed in a radial direction of the planetary gear mechanism, and the power switching mechanism is located at the portion where the inner circumference of the ring gear and the outer circumference of the carrier are opposed.

In one example, the power switching mechanism includes a groove formed in one of the inner circumference of the ring gear and the outer circumference of the carrier and having different depths in a circumferential direction and a rolling element located in the groove.

In one example, the groove shallows from an intermediate portion toward two opposite ends in the circumferential direction. In one example, the power switching mechanism further includes a first biasing member, a second biasing member, and a housing in which the planetary gear mechanism is located. The first biasing member applies force that is directed toward one end of the groove to the rolling element. The second biasing member is supported by the housing in a slidable manner. In a case in which the crankshaft inputs rotation to the input body in the second rotation direction, the second biasing member applies force that is directed toward another end of the groove to the rolling element.

In one example, the input body is a carrier, the output body is a ring gear, and the transmission body is a sun gear. In one example, the power switching mechanism is at least partially located between the ring gear and the carrier or the crankshaft.

In one example, the crankshaft and the ring gear include a portion where an outer circumference of the crankshaft and an inner circumference of the ring gear are opposed in a radial direction of the planetary gear mechanism, and the power switching mechanism is located at the portion where the inner circumference of the ring gear and the outer circumference of the crankshaft are opposed.

In one example, the power switching mechanism includes a switching portion located at the portion where the outer circumference of the crankshaft and the inner circumference of the ring gear are opposed. The switching portion includes a rotation shaft that is coupled to the carrier and parallel to an axial direction of the carrier and a pawl that is rotatably supported by the rotation shaft. In the switching portion, in a case in which the crankshaft is rotated in the first rotation direction, the pawl is separated from at least one of the crankshaft and the ring gear, and in a case in which the crankshaft is rotated in the second rotation direction, the pawl is rotated about the rotation shaft, thereby bringing the pawl into contact with the crankshaft and the ring gear and connecting the carrier and the ring gear.

In one example, the power switching mechanism further includes a projection, a first groove, a second groove, and a biasing member. The projection is formed on one of the outer circumference of the crankshaft and the inner circumference of the carrier at the portion where the outer circumference of the crankshaft and the inner circumference of the carrier are opposed. The first groove is formed in the other one of the outer circumference of the crankshaft and the inner circumference of the carrier at the portion where the outer circumference of the crankshaft and the inner circumference of the carrier are opposed. The first groove receives the projection so that the carrier is movable relative to the ring gear. The second groove is formed in the inner circumference of the ring gear at a portion opposing the outer circumference of the crankshaft. The biasing member applies force to the pawl. The biasing member applies force that pushes the pawl against the outer circumference of the crankshaft. In a case in which the crankshaft is rotated in the first rotation direction, movement of the crankshaft relative to the carrier in the first rotation direction rotates and removes the pawl from the second groove of the ring gear to separate the pawl from the ring gear. In a case in which the crankshaft is rotated in the second rotation direction, movement of the crankshaft relative to the carrier in the second rotation direction rotates the pawl into the second groove of the ring gear to fit the pawl into the second groove of the ring gear, thereby connecting the carrier and the ring gear.

In one example, the bicycle drive unit further includes a housing that accommodates at least the planetary gear mechanism and a one-way clutch located between the sun gear and the housing. The one-way clutch allows the sun gear to rotate relative to the housing only in a single rotation direction.

In one example, the bicycle drive unit further includes a housing that accommodates at least the planetary gear mechanism and a one-way clutch located between an output shaft of the first motor or a rotor of the first motor and the housing. The one-way clutch allows the output shaft of the first motor or the rotor of the first motor to rotate relative to the housing in a single rotation direction.

In one example, the sun gear is arranged around the crankshaft to be coaxially with the crankshaft. In one example, the first motor is arranged around the crankshaft to be coaxially with the crankshaft.

In one example, the sun gear is integrally formed with an output shaft of the first motor. In one example, the bicycle drive unit further includes an output portion connected to the output body. A front sprocket is attachable to the output portion.

In one example, the bicycle drive unit further includes the crankshaft. In one example, the bicycle drive unit further includes a second motor that transmits torque to the output body or the input body.

In one example, the second motor includes a rotation shaft, and the rotation shaft of the second motor is separated from the crankshaft in a radial direction of the crankshaft. In one example, the bicycle drive unit further includes a controller that controls the first motor and the second motor.

The present invention obtains a bicycle drive unit that is configured to perform coaster braking. Other aspects and advantages of the present invention will become apparent from the following description, taken in conjunction with the accompanying drawings, illustrating by way of example the principles of the invention.

### BRIEF DESCRIPTION OF THE DRAWINGS

FIG. 1 is a side view of a bicycle to which a first embodiment of a bicycle drive unit is installed.

FIG. 2 is a cross-sectional view showing the bicycle drive unit of FIG. 1.

FIG. 3 is a schematic diagram showing a rotation direction of each component in a planetary gear mechanism of FIG. 1.

FIG. 4 is an enlarged cross-sectional view showing a power switching mechanism of FIG. 2.

FIG. 5 is a cross-sectional view taken along line 5-5 in FIG. 4.

FIG. 6 is a cross-sectional view of a state in which a crankshaft is rotated in a reverse rotation direction in FIG. 5.

FIG. 7 is a schematic diagram showing a rotation direction of each component in the planetary gear mechanism in a state in which the crankshaft of FIG. 2 is rotated in the reverse rotation direction.

FIG. 8 is a cross-sectional view showing the planetary gear mechanism of FIG. 5 in which a ring gear and a carrier are integrally rotated in a forward rotation direction.

FIG. 9 is a cross-sectional view showing a second embodiment of a bicycle drive unit.

FIG. 10 is a schematic diagram showing a rotation direction of each component in a planetary gear mechanism of FIG. 9.

FIG. 11 is an enlarged cross-sectional view showing a power switching mechanism of FIG. 10.

FIG. 12 is a cross-sectional view taken along line 12-12 in FIG. 11.

FIG. 13 is a cross-sectional view of a state in which a crankshaft is rotated in a reverse rotation direction in FIG. 12.

FIG. 14 is a schematic diagram showing a modified example of the bicycle drive unit of the second embodiment.

### DETAILED DESCRIPTION OF THE EMBODIMENTS

### First Embodiment

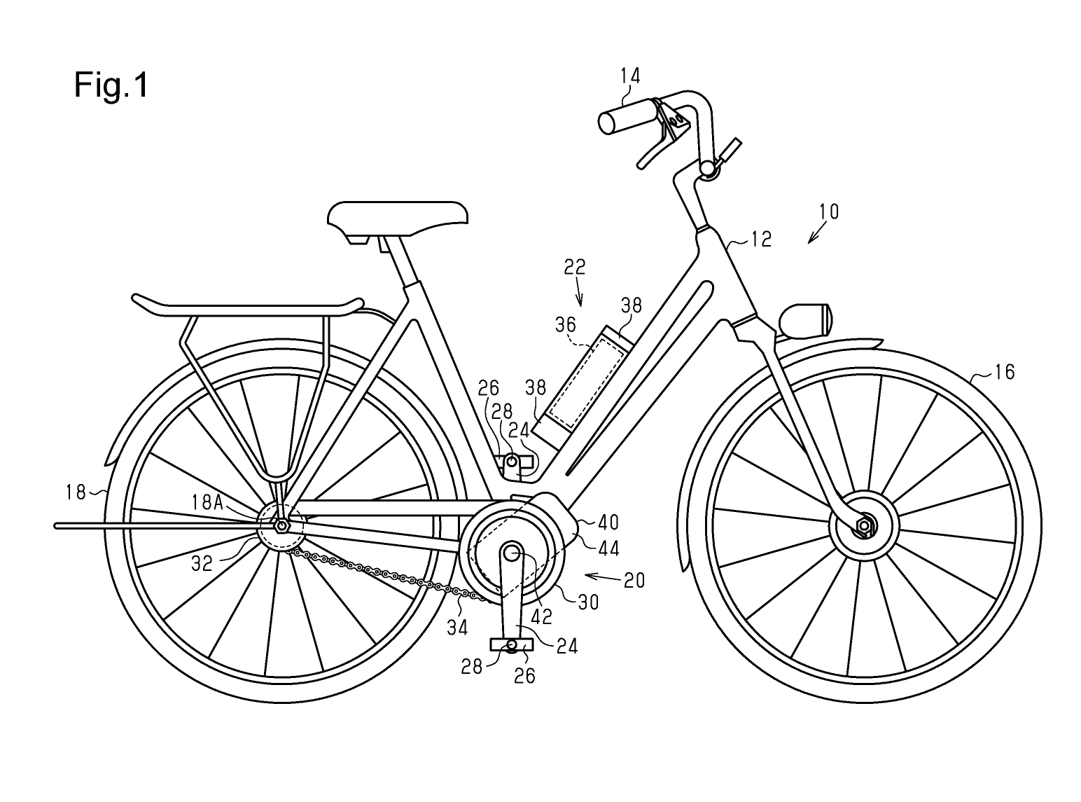

The structure of a bicycle to which a bicycle drive unit is installed will now be described with reference to FIG. 1. A bicycle 10 includes a frame 12, a handlebar 14, a front wheel 16, a rear wheel 18, a drive mechanism 20, a battery unit 22, and a drive unit 40.

The drive mechanism 20 includes left and right crank arms 24, left and right pedals 26, a front sprocket 30, a rear sprocket 32, and a chain 34. The drive unit 40 includes a crankshaft 42, which rotatably couples the left and right crank arms 24 to the frame 12. The pedals 26 are coupled to the crank arms 24 so as to be rotatable about pedal shafts 28.

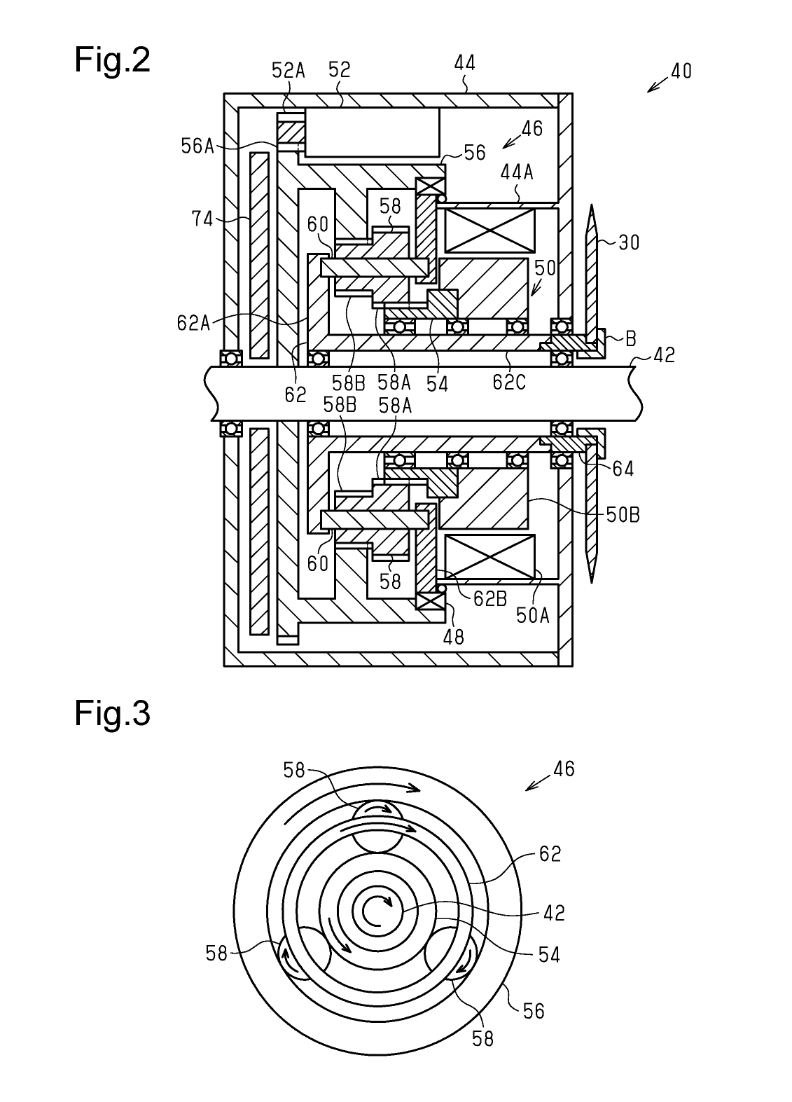

The drive unit 40 includes an output portion 64 (refer to FIG. 2), to which the front sprocket 30 is coupled. The front sprocket 30 is arranged coaxially with the crankshaft 42. The rear wheel 18 includes an axle 18A. The rear sprocket 32 is coupled to be rotatable about the axle 18A of the rear wheel 18. The chain 34 runs around the front sprocket 30 and the rear sprocket 32. In a state in which human power is applied to the pedals 26 to rotate the crank arms 24, the rear wheel 18 is rotated by the front sprocket 30, the chain 34, and the rear sprocket 32.

The battery unit 22 includes a battery 36 and a battery holder 38, which attaches the battery 36 to the frame 12 in a removable manner. The battery 36 includes one or more battery cells. The battery 36 is formed by a rechargeable battery. The battery 36 is electrically connected to the drive unit 40 to supply electric power to the drive unit 40.

As shown in FIG. 2, the drive unit 40 includes a planetary gear mechanism 46, a power switching mechanism 48, and a first motor 50. Additionally, the drive unit 40 can include the crankshaft 42, a housing 44, and a second motor 52.

The housing 44 accommodates the planetary gear mechanism 46, the power switching mechanism 48, the first motor 50, and the second motor 52. The housing 44 rotatably supports the crankshaft 42. The crankshaft 42 extends through the housing 44.

The planetary gear mechanism 46 includes a sun gear 54, a ring gear 56, a plurality of planetary gears 58, a plurality of planetary pins 60, and a planetary carrier 62 (also simply referred to as “the carrier”). The ring gear 56 functions as an input body to which rotation of the crankshaft 42 is inputted. The carrier 62 functions as an output body that externally outputs rotation of the planetary gear mechanism 46. The sun gear 54 functions as a transmission body.

The sun gear 54 is arranged around the crankshaft 42 to be coaxially with the crankshaft 42. The ring gear 56 is located at an outer side of the sun gear 54 in a radial direction of the crankshaft 42. The ring gear 56 is arranged around the crankshaft 42 to be coaxially with the crankshaft 42. Thus, the ring gear 56 is arranged around the sun gear 54 coaxially with the sun gear 54. The crankshaft 42 is connected to an inner circumference (central portion) of the ring gear 56, for example, by spline fitting or press fitting. Rotation of the crankshaft 42 is inputted to the ring gear 56. This integrally rotates the ring gear 56 with the crankshaft 42.

The planetary gears 58 are arranged between the sun gear 54 and the ring gear 56. Each of the planetary gears 58 includes a large diameter portion 58A and a small diameter portion 58B. The large diameter portion 58A includes an outer circumferential gear, which is opposed to an outer circumference of the sun gear 54 and engaged with the sun gear 54. The small diameter portion 58B includes an outer circumferential gear, which is opposed to an inner circumference of the ring gear 56 and engaged with the ring gear 56. Instead of the planetary gear 58 including the large diameter portion 58A and the small diameter portion 58B, a general planetary gear having a single gear can he used.

The planetary pins 60 respectively extend through the planetary gears 58 in an axial direction. Each of the planetary pins 60 rotatably supports the corresponding one of the planetary gears 58. The planetary pin 60 includes two opposite ends, which are rotatably supported by the carrier 62. In a case in which the two opposite ends of the planetary pin 60 are rotatably supported by the carrier 62, the planetary pin 60 can be non-rotatably supported by the planetary gear 58. In a case in which the planetary pin 60 rotatably supports the planetary gear 58, the two opposite ends of the planetary pin 60 can be non-rotatably supported by the carrier 62.

The carrier 62 is arranged around the crankshaft 42 to be coaxially with the crankshaft 42. The planetary gears 58 are rotatably held by the planetary pins 60 on the carrier 62. Thus, the planetary gears 58 orbit the sun gear 54 between the sun gear 54 and the ring gear 56.

The carrier 62 includes a first carrier 62A, which supports one end of each planetary pin 60, and a second carrier 62B, which supports another end of the planetary pin 60. The first carrier 62A is opposed to an end of the small diameter portion 58B of each planetary gear 58 in the axial direction. The second carrier 62B is opposed to an end of the large diameter portion 58A of the planetary gear 58. The first carrier 62A and the second carrier 62B, which are coupled to each other in a relatively immovable manner, are integrally rotated. The first carrier 62A and the second carrier 62B can be integrally formed.

The first carrier 62A includes a tubular coupling portion 62C, which is located in a gap formed between an inner circumference of the sun gear 54 and the crankshaft 42. The coupling portion 62C includes an end to which the output portion 64 is connected. The output portion 64 includes one end that is accommodated in the housing 44 and another end that is exposed from the housing 44. A bolt B is fastened to an inner circumference of the portion of the output portion 64 exposed from the housing 44. The front sprocket 30 is supported by spline on the output portion 64 so as to be non-rotatable in the circumferential direction. The front sprocket 30 is coupled by the bolt B to the output portion 64 so as to be immovable in the axial direction. The output portion 64 can be integrally formed with the coupling portion 62C.

The first motor 50 is arranged around the crankshaft 42 to be coaxially with the crankshaft 42. The first motor 50 is located at a position adjacent to the planetary gear mechanism 46 in the axial direction of the crankshaft 42. The first motor 50 is located between the planetary gear mechanism 46 and the front sprocket 30 in the axial direction of the crankshaft 42.

The first motor 50, which is of an inner rotor type, includes a stator 50A that is supported by the housing 44 and a rotor 50B that is located at a circumferentially inner side of the stator 50A. The rotor 50B includes an axial end that is coupled to an end of the sun gear 54. More specifically, the first motor 50 includes an output shaft that is integrally formed with the sun gear 54. The rotor SOB and the sun gear 54 are rotatable relative to the crankshaft 42. The first motor 50 transmits torque to the sun gear 54 to control rotation of the sun gear 54. The stator 50A is fixed to the housing 44.

The second motor 52 includes a rotation shaft, which is located at a position separated from the crankshaft 42 in the radial direction of the crankshaft 42. The second motor 52 includes an output gear 52A. The ring gear 56 includes an outer circumferential gear 56A, which engages the output gear 52A. The second motor 52 transmits torque to the ring gear 56 through the gear 56A. Additionally, a one-way clutch can be arranged in a power transmission path extending between the rotation shaft of the second motor 52 and the ring gear 56. The one-way clutch, which transmits rotation of the second motor 52 to the ring gear 56, is configured not to transmit rotation of the ring gear 56 to the second motor 52 in a case in which the crankshaft 42 is rotated in a single rotation direction.

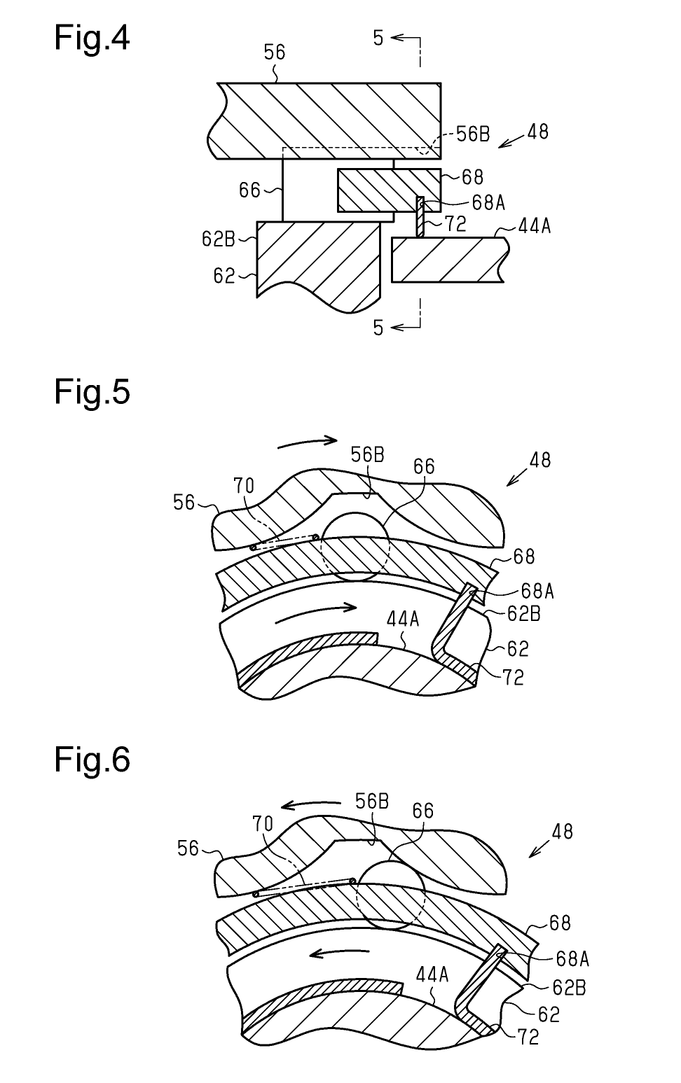

As shown in FIG. 4, the power switching mechanism 48 is located between the carrier 62 and the ring gear 56, preferably, at a portion where an outer circumference of the second carrier 62B and the inner circumference of the ring gear 56 are opposed in the radial direction. The power switching mechanism 48 includes a plurality of rolling elements 66, a retainer 68 that holds the rolling elements 66, a first biasing member 70 (refer to FIG. 5), and a second biasing member 72.

Referring to FIG. 5, grooves 56B are formed in the inner circumference of the ring gear 56. The rolling elements 66 are located in the grooves 56B. Each of the grooves 56B has different depths in the circumferential direction. The groove 56B shallows from an intermediate portion toward two opposite ends in the circumferential direction.

The first biasing member 70 is coupled to a wall defining one of the grooves 56B and the retainer 68. The first biasing member 70 applies force that is directed toward the first end of the groove 56B to the rolling elements 66. In the present embodiment, the direction in which the first biasing member 70 applies the force to the rolling elements 66 is opposite (reverse) to the direction in which the crankshaft 42 is rotated to move the bicycle 10 forward.

The second biasing member 72 is an annular spring member. The second biasing member 72 is a sliding spring. The second biasing member 72 includes an annular portion, which is fitted to a tubular support portion 44A located in the housing 44. The support portion 44A extends from an inner wall of the housing 44. The second biasing member 72 includes two circumferentially opposite ends, which are separated from each other. One of the ends of the second biasing member 72 is fitted into a groove 68A formed in the retainer 68. The second biasing member 72 is supported by the support portion 44A in a slidable manner. Thus, in a case in which the crankshaft 42 inputs rotation in a second rotation direction (for example, reverse rotation direction) to the ring gear 56, the second biasing member 72 applies force that is directed toward the second end of the groove 56B to the rolling elements 66. In this state, the direction in which the second biasing member 72 applies the force to the rolling elements 66 conforms to the rotation direction (for example, forward rotation direction) of the crankshaft 42 that moves the bicycle 10 forward. In a case in which the crankshaft 42 inputs rotation in a first rotation direction (for example, forward rotation direction) to the ring gear 56, the second biasing member 72 applies force that is directed toward the first end of the groove 56B to the rolling elements 66.

As shown in FIG. 5, in a case in which the crankshaft 42 inputs the forward rotation to the ring gear 56 to rotate the ring gear 56 in the forward rotation direction and the carrier 62 is rotated faster than the ring gear 56 in the forward rotation direction, sliding fiction of the rolling elements 66 and the carrier 62 is greater than biasing force applied by the first biasing member 70 and the second biasing member 72 toward one side of the groove 56B. Thus, the rolling elements 66 are set in a deep portion, which can be the middle of the two opposite ends, of the groove 56B. This allows for relative rotation of the ring gear 56 and the carrier 62.

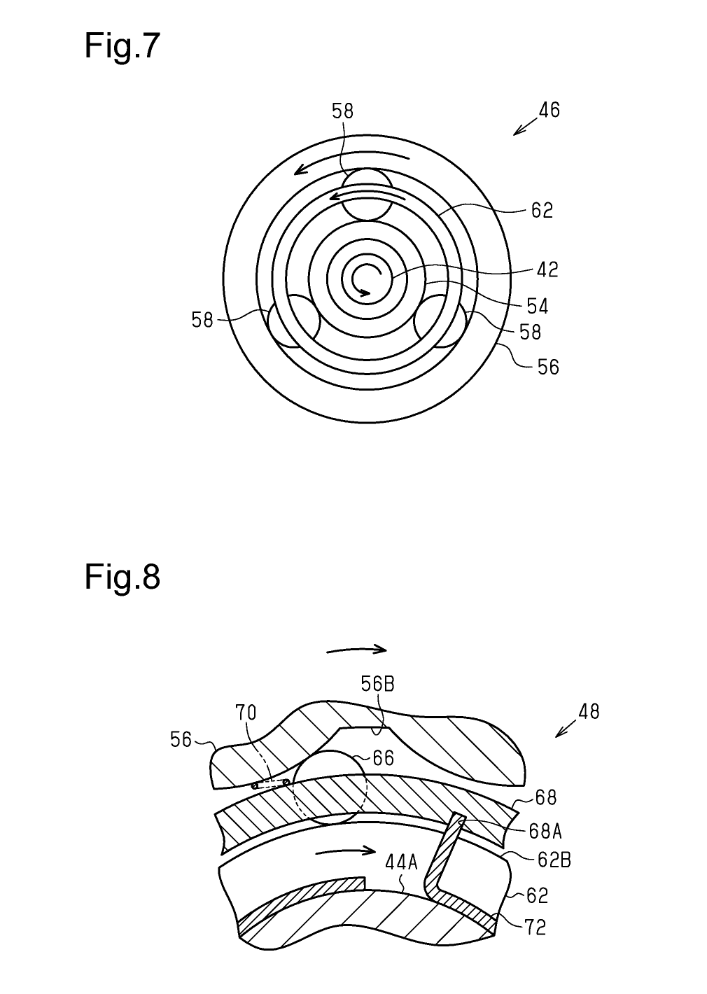

As shown in FIG. 6, in a case in which the crankshaft 42 inputs the reverse rotation to the ring gear 56 to rotate the ring gear 56 in the reverse rotation direction, sliding friction of the second biasing member 72 against the support portion 44A is increased. Thus, the second biasing member 72 applies force acting in the forward rotation direction to the rolling elements 66 through the retainer 68. This moves the rolling elements 66 to the shallow portion of the groove 56B defining the second end. The rolling elements 66 connect the ring gear 56 and the carrier 62. Consequently, the carrier 62 is rotated in the reverse rotation direction. As described above, as shown in FIG. 7, in a case in which the crankshaft 42 inputs the reverse rotation to the ring gear 56, the ring gear 56 and the carrier 62 are integrally rotated in the reverse rotation direction. In a case in which the crankshaft 42 is rotated in the reverse rotation direction, a controller 74 stops the supply of power to the first motor 50.

As shown in FIG. 8, in a state in which the crankshaft 42 inputs the forward rotation to the ring gear 56 to rotate the ring gear 56 in the forward rotation direction and rotation of the carrier 62 conforms to the rotation of the ring gear 56 in the forward rotation direction, the first biasing member 70 and the second biasing member 72 cooperate to move the rolling elements 66 to the shallow portion of the groove 56B defining the first end. The rolling elements 66 connect the ring gear 56 and the carrier 62. Consequently, the carrier 62 and the ring gear 56 are integrally rotated in the forward rotation direction. The rolling elements 66 connect the ring gear 56 and the carrier 62 to allow for the integral rotation of the ring gear 56 and the carrier 62 until the carrier 62 is rotated faster than the ring gear 56.

As shown in FIG. 2, the drive unit 40 further includes the controller 74. The controller 74 is accommodated in the housing 44. The controller 74 includes a drive circuit that drives the first motor 50 and a drive circuit that the second motor 52. The controller 74 drives the first motor 50 and the second motor 52 with power supplied from the battery 36 (refer to FIG. 1). The controller 74 controls the first motor 50 and the second motor 52, for example, based on a signal received from a torque sensor and a vehicle speed sensor (not shown) or the like. The torque sensor detects human power. The torque sensor can be realized, for example, by a strain sensor located on the ring gear 56. In this case, an output from the strain sensor is provided to the controller 74 through a wireless communication device, a slip ring, or the like. The strain sensor is, for example, a strain gauge. Instead of using the torque sensor, the controller 74 can calculate torque based on electric current applied to at least one of the first motor 50 and the second motor 52. Additionally, in a case in which the controller 74 receives an operation signal for changing a gear ratio GR of the planetary gear mechanism 46, which is the ratio of the number of rotations outputted from the planetary gear mechanism 46 to the number of rotations inputted to the planetary gear mechanism 46, the controller 74 controls the first motor 50 so that the ratio of rotations of the output portion 64 to rotations of the crankshaft 42 is set to a predetermined gear ratio. Additionally, in a case the controller 74 receives an operation signal for changing assist power from an operation unit (not shown), the controller 74 controls the second motor 52 so that an output of the second motor 52 is increased relative to human power. The controller 74 can be connected to the first motor 50 and the second motor 52, for example, by a conductive element.

The controller 74 drives the first motor 50 to transmit torque to the sun gear 54 in the reverse rotation direction. Consequently, as shown in FIG. 3, the rotation of the sun gear 54 increases the spinning speed of the planetary gears 58, which are rotated around the sun gear 54. This increases the rotation speed of the carrier 62 and the gear ratio GR. The gear ratio GR is changed through continuously variable transmission in accordance with the rotation speed of the sun gear 54. Alternatively, the controller 74 can perform control so that the gear ratio GR, that is, the rotation speed of the sun gear 54, is changed in a stepped manner. Alternatively, in a case in which the controller 74 is connected to an external device through wireless or wired communication, the external device can be used to change the gear position and the value of the gear ratio GR. The external device is, for example, a cyclometer or a personal computer.

The controller 74 drives the second motor 52 to transmit torque to the carrier 62 in the forward rotation direction. This adds assist power to the torque inputted to the crankshaft 42 and outputs the power from the planetary gear mechanism 46.

In the planetary gear mechanism 46, the ring gear 56 functions as an input portion, and the carrier 62 is connected to the output portion 64. Thus, in a state in which the sun gear 54 is not rotated relative to the housing 44, rotation inputted to the planetary gear mechanism 46 is decreased in speed and outputted. In a state in which the rotation speed of the carrier 62 is less than or equal to the rotation speed of the ring gear 56, the power switching mechanism 48 integrally rotates the carrier 62 and the ring gear 56. Thus, in a state in which the controller 74 performs control for stopping the rotation of the sun gear 54 relative to the housing 44, the gear ratio GR is one.

The drive unit 40 has the operations and advantages described below.

(1) The drive unit 40 includes the power switching mechanism 48, which rotates the carrier 62 in the reverse rotation direction in a state in which the crankshaft 42 inputs the reverse rotation to the ring gear 56. Therefore, in a case in which the rider rotates the crank arms 24 in the reverse rotation direction, torque is transmitted to the ring gear 56 and the front sprocket 30 in the reverse rotation direction. This allows the drive unit 40 to perform coaster braking. The power switching mechanism 48 is mechanically structured and is of a nonelectric type. This allows the coaster braking to be performed regardless of whether or not a battery is arranged.

(2) In a case in which the crankshaft 42 inputs the reverse rotation to the ring gear 56, the power switching mechanism 48 connects and integrally rotates the ring gear 56 and the carrier 62. Thus, torque loss in the planetary gear mechanism 46 is reduced as compared to a structure in which the reverse rotation of the ring gear 56 is changed in speed and transmitted to the carrier 62 by the planetary gear mechanism 46. This is preferable from the viewpoint of the coaster braking performance. Additionally, in a case in which the crankshaft 42 is rotated in the reverse rotation direction, the moved angle of the crankshaft 42 conforms to the moved angle of the front sprocket 30. Thus, the rider will hardly sense any awkwardness with the drive unit 40 during coaster braking.

(3) The power switching mechanism 48, which allows for relative rotation of the ring gear 56 and the carrier 62, connects and integrally rotates the ring gear 56 and the carrier 62 until the carrier 62 is rotated faster than the ring gear 56. Thus, even in a case in which the supply of power to the first motor 50 is stopped, the planetary gear mechanism 46 is able to output rotation. The drive unit 40 is able to stop the supply of power to the first motor 50 in a state in which the gear ratio GR is one. This contributes to a reduction in power consumption as compared to a configuration in which power is supplied to the first motor 50 to maintain the phase of the sun gear 54 relative to the housing 44.

(4) The drive unit 40 uses the single power switching mechanism 48 to obtain the function of coaster braking and the function for restricting rotation of the sun gear 54 relative to the housing 44 in a state in which the supply of power to the first motor 50 is stopped. This simplifies the structure of the drive unit 40 as compared to a case in which these functions are realized by different mechanisms.

(5) The first motor 50 is arranged around the crankshaft 42 to be coaxially with the crankshaft 42. This limits enlargement of the drive unit 40 in the radial direction of the crankshaft 42 as compared to a structure in which the first motor 50 is located at a radially outer side of the crankshaft 42.

(6) The sun gear 54 is integrally formed with the output shaft of the first motor 50. This contributes to a reduction in the number of components in the drive unit 40.

(7) The rotation shaft of the second motor 52 is separated from the crankshaft 42 in the radial direction of the crankshaft 42. This limits enlargement in the axial direction of the crankshaft 42 as compared to a case in which the rotation shaft of the second motor 52 is arranged coaxially with the crankshaft 42 of the drive unit 40.

(8) The output portion 64 is offset from the planetary gear mechanism 46 in the axial direction of the crankshaft 42. This facilitates the coupling and removal of the front sprocket 30 as compared to a structure in which a portion to which the front sprocket 30 is coupled is located in an inner portion of the planetary gear mechanism 46 in the axial direction of the crankshaft 42.

(9) The drive unit 40 includes the second motor 52, which transmits torque to the carrier 62, and the first motor 50, which transmits torque to the sun gear 54 to control the rotation of the sun gear 54. Thus, changes in the gear ratio GR and changes in assist power are independently performed by the first motor 50 and the second motor 52, respectively. This further allows control to be performed in accordance with a riding condition or the like.

### Second Embodiment

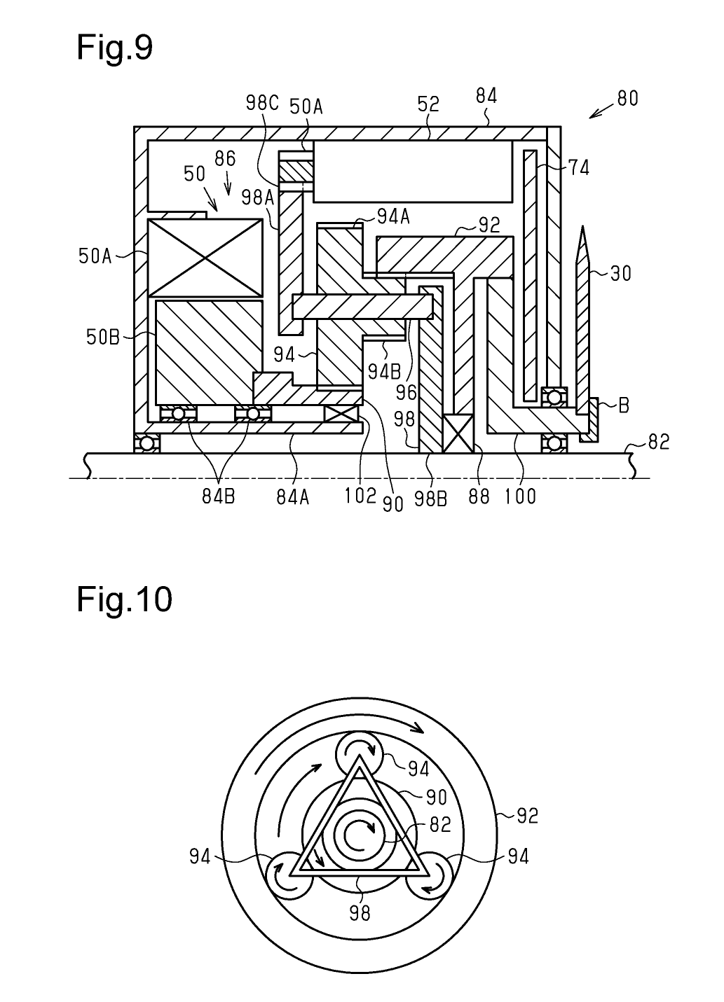

A second embodiment of a drive unit 80 will now be described with reference to FIGS. 9 to 13. As shown in FIG. 9, the drive unit 80 includes a crankshaft 82, a housing 84, a planetary gear mechanism 86, a power switching mechanism 88, the first motor 50, the second motor 52, and the controller 74. second motor 52, and the controller 74.

The housing 84 accommodates the planetary gear mechanism 86, the power switching mechanism 88, the first motor 50, the second motor 52, and the controller 74. The housing 84 rotatably supports the crankshaft 82. The crankshaft 82 extends through the housing 84.

The planetary gear mechanism 86 includes a sun gear 90, which is a transmission body, a ring gear 92, which is an output body that externally outputs rotation of the planetary gear mechanism 86, a plurality of planetary gears 94, a plurality of planetary pins 96, and a carrier 98, which is an input body to which rotation of the crankshaft 82 is inputted.

The sun gear 90 is arranged around the crankshaft 82 coaxially with the crankshaft 82. The ring gear 92 is arranged around the sun gear 90 coaxially with the sun gear 90. The ring gear 92 is connected to an output portion 100. The output portion 100 includes one end that is accommodated in the housing 84 and another end that is exposed from the housing 84. A bolt B is fastened to an inner circumference of the portion of the output portion 100 exposed from the housing 84. The ring gear 92 and the output portion 100 can be integrally formed.

The planetary gears 94 are located between the sun gear 90 and the ring gear 92. Each of the planetary gears 94 includes a large diameter portion 94A and a small diameter portion 94B. The large diameter portion 94A includes an outer circumferential gear, which is opposed to an outer circumference of the sun gear 90 and engaged with the sun gear 90. The small diameter portion 94B includes an outer circumferential gear, which is opposed to the inner circumference of the ring gear 92 and engaged with the ring gear 92. Although the planetary gear 94 including the large diameter portion 94A and the small diameter portion 94B is used, a general planetary gear having a single gear can be used.

The planetary pins 96 respectively extend through the planetary gears 94 in the axial direction. Each of the planetary pins 96 rotatably supports the corresponding one of the planetary gears 94. The planetary pin 96 includes two opposite ends, which are rotatably supported by the carrier 98. In a case in which the two opposite ends of the planetary pin 96 is rotatably supported by the carrier 98, the planetary pin 96 can be non-rotatably supported by the planetary gear 94. In a case in which the planetary pin 96 rotatably supports the planetary gear 94, the two opposite ends of the planetary pin 96 can be non-rotatably supported by the carrier 98.

The carrier 98 is arranged around the crankshaft 82 coaxially with the crankshaft 82. The planetary gears 94 are rotatably held by the planetary pins 96 on the carrier 98. Thus, the planetary gears 94 orbit the sun gear 90 between the sun gear 90 and the ring gear 92.

The carder 98 includes a first carrier 98A, which supports one end of each planetary pin 96, and a second carrier 98B, which supports another end of the planetary pin 96. The first carrier 98A is opposed to an end of the small diameter portion 94B of each planetary gear 94. The second carrier 98B is opposed to an end of the large diameter portion 94A of the planetary gear 94. The first carrier 98A and the second carrier 98B, which are coupled to each other in a relatively immovable manner, are integrally rotated. The first carrier 98A and the second carrier 98B can be integrally formed.

The inner circumference of the second carrier 98B and the outer circumference of the crankshaft 82 include opposing portions. As shown in FIG. 12, a projection 98D projects from the inner circumference of the second carrier 98B toward the crankshaft 82. A first groove 82A extends in a portion of the crankshaft 82 opposing the projection 98D. The projection 98D is fitted into the first groove 82A. The first groove 82A is larger than the projection 98D in the circumferential direction. This allows the second carrier 98B to move relative to the crankshaft 82 over a distance corresponding to the difference in the size in the circumferential direction between the first groove 82A and the projection 98D.

As shown in FIG. 9, the first motor 50 is located at a position adjacent to the planetary gear mechanism 86 in the axial direction of the crankshaft 82. The first motor 50 and the front sprocket 30 are located at opposite sides of the planetary gear mechanism 86 in the axial direction of the crankshaft 82.

The housing 84 includes a support portion 84A, which is located between the inner circumference of the rotor 50B of the first motor 50 and the crankshaft 82. The support portion 84A is tubular and coaxial with the crankshaft 82. The rotor 50B is rotatably supported by the support portion 84A. The rotor SOB is supported by two bearings 84B on the support portion 84A. The rotor 50B includes an axial end to which an end of the sun gear 90 is coupled. More specifically, the first motor 50 includes an output shaft that is formed integrally with the sun gear 90. The rotor 50B and the sun gear 90 are rotatable relative to the crankshaft 82. The first motor 50 transmits torque to the sun gear 90 to control rotation of the sun gear 90. The stator 50A is fixed to the housing 84.

The support portion 84A includes a part extending in a gap formed between the inner circumference of the sun gear 90 and the crankshaft 82. A one-way clutch 102 is located between the inner circumference of the sun gear 90 and the outer circumference of the support portion 84A. The one-way clutch 102 allows the sun gear 90 to rotate relative to the support portion 84A only in a single rotation direction. The one-way clutch 102 allows the sun gear 90 to rotate relative to the support portion 84A only in, for example, the reverse rotation direction. Thus, the sun gear 90 cannot rotate relative to the support portion 84A in the forward rotation direction. In a state in which power is not supplied to the first motor 50, if the crankshaft 82 inputs rotation in the forward rotation direction, the one-way clutch 102 restricts rotation of the sun gear 90. Thus, the forward rotation of the crankshaft 82 is increased in speed and transmitted to the output portion 100 by the planetary gear mechanism 86. The one-way clutch 102 can be formed by a roller clutch or a pawl-type clutch.

The outer circumference of the second carrier 98B includes a gear 98C, which engages with the output gear 52A of the second motor 52. The second motor 52 transmits torque to the carrier 98 through the gear 98C. Additionally, a one-way clutch can be located between a power transmission path extending between the rotation shaft of the second motor 52 and the carrier 98. The one-way clutch, which transmits rotation of the second motor 52 to the carrier 98, is configured not to transmit the rotation of the carrier 98 to the second motor 52 in a case in which the crankshaft 82 is rotated in one direction.

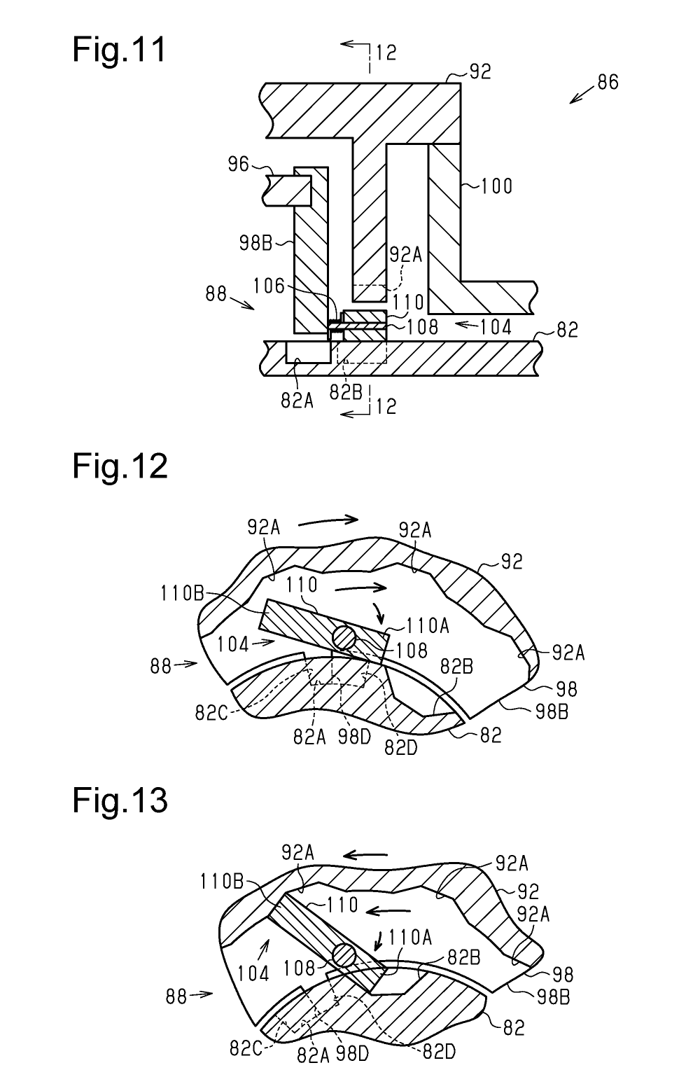

As shown in FIG. 11, the power switching mechanism 88 is located between the crankshaft 82 and the ring gear 92, preferably, at a portion where the outer circumference of the crankshaft 82 and the inner circumference of the ring gear 92 are opposed in the radial direction of the planetary gear mechanism 86. The power switching mechanism 88 includes a switching portion 104 and a biasing member 106. The ring gear 92 includes a central inner circumference in which second grooves 92A are formed at positions opposing a pawl 110 of the power switching mechanism 88. The second grooves 92A are separated from one another in the circumferential direction, for example, at equal intervals.

The switching portion 104 is coupled to the second carrier 98B, more specifically, an inner circumferential portion of the second carrier 98B. The switching portion 104 includes a rotation shaft 108, which is coupled to the second carrier 98B and parallel to the axial direction of the second carrier 98B, and the pawl 110, which is supported so as to be rotatable about the rotation shaft 108. The biasing member 106 applies force to the pawl 110 such that one end 110A of the pawl 110 is pushed against the outer circumference of the crankshaft 82. The crankshaft 82 includes a third groove 82B at a portion where the pawl 110 is placed.

As shown in 12, in a case in which the crankshaft 82 inputs rotation to the carrier 98 in the forward rotation direction, the crankshaft 82 is moved relative to the carrier 98 in one direction (for example, forward rotation direction). Consequently, a reverse rotation side end wall 82C of the first groove 82A in the crankshaft 82 pushes the projection 98D of the second carrier 98B. This integrally rotates the crankshaft 82 and the second carrier 98B in the forward rotation direction. In this state, the end 110A of the pawl 110 is pushed by a portion of the outer circumference of the crankshaft 82 that does not include the third groove 82B in a direction opposite to the direction in which the biasing member 106 biases. Thus, another end 110B of the pawl 110 is moved in a direction directed away from the second grooves 92A of the ring gear 92. Therefore, the pawl 110 is in contact with the portion of the outer circumference of the crankshaft 82 that does not include the third groove 82B but separated from and not in contact with the inner surface of the ring gear 92. This allows for relative rotation of the carrier 98 and the ring gear 92. In a case in which the crankshaft 82 is rotated in the forward rotation direction, the pawl 110 is maintained in a state contacting the portion of the outer circumference of the crankshaft 82 that does not include the third groove 82B and a state separated from the second grooves 92A of the ring gear 92. Thus, the relative rotation of the carrier 98 and the ring gear 92 is allowed regardless of the relationship between the rotation speed of the crankshaft 82 and the rotation speed of the carrier 98.

As shown in FIG. 13, in a case in which the crankshaft 82 inputs rotation the carrier 98 in the reverse rotation direction, the projection 98D is moved in the first groove 82A, and a forward rotation side end wall 82D of the first groove 82A in the crankshaft 82 pushes the projection 98D of the second carrier 98a This integrally rotates the crankshaft 82 and the second carrier 98B in the reverse rotation direction. At this time, the end 110A of the pawl 110 is moved to a portion of the outer circumference of the crankshaft 82 where the third groove 82B is formed. Thus, the pawl 110 is rotated about the rotation shaft 108 by the force of the biasing member 106 (refer to FIG. 11) so that the end 110A of the pawl 110 is moved into the third groove 82B. Accordingly, the end 110B of the pawl 110, which is moved in a direction extending toward the ring gear 92, is fitted into one of the second grooves 92A in the ring gear 92 and comes into contact with a wall surface of the second groove 92A. This connects the second carrier 98B and the ring gear 92. Thus, the ring gear 92 and the carrier 98 are integrally rotated in the reverse rotation direction.

The controller 74 drives the first motor 50 to transmit torque to the sun gear 90 in the reverse rotation direction. Consequently, as shown in FIG. 10, the rotation of the sun gear 90 increases the spinning speed of the planetary gears 94, which are rotated around the sun gear 90. This increases the rotation speed of the ring gear 92 and the gear ratio GR. The gear ratio GR is changed through continuously variable transmission in accordance with the rotation speed of the sun gear 90.

In a case in which the controller 74 shown in FIG. 9 stops the supply of power to the first motor 50, the driving of the first motor 50 is stopped. The one-way clutch 102, which is located between the sun gear 90 and the support portion 84A, restricts rotation of the sun gear 90 relative to the support portion 84A. Thus, in a case in which the controller 74 stops the supply of power to the first motor 50, the gear ratio GR is maintained at a gear ratio GR that corresponds to the number of teeth of each component in the planetary gear mechanism 86. In the planetary gear mechanism 86, the carrier 98 functions as an input portion, and the ring gear 92 is connected to the output portion 100. Thus, in a state in which the sun gear 90 is not rotated relative to the support portion 84A, rotation inputted to the planetary gear mechanism 86 is increased in speed and outputted. Therefore, in a state in which the controller 74 stops the supply of power to the first motor 50, the gear ratio GR is one or greater, and, for example, 1.2 or greater. It is preferred that the first motor 50 change the gear ratio GR in a range including at least from 1.2 to 1.5. The maximum value of the gear ratio GR changed by the first motor 50 is, for example, at most 3.0. In other words, the first motor 50 changes the gear ratio GR in a range from 1 to 3.0.

The drive unit 40 has the operations and advantages described below in addition to advantages corresponding to (1) to (3) and (5) to (9) of the first embodiment.

(10) In a state in which the first motor 50 does not produce rotation, the planetary gear mechanism 86 has the gear ratio GR that is set to one or greater. Thus, as compared to a planetary gear mechanism having the gear ratio GR that is set to less than one in a state in which the first motor 50 does not produce rotation, the range of the gear ratio GR can be increased in a region that is greater than or equal to one without enlargement of the first motor 50.

(11) Since the gear ratio GR of the planetary gear mechanism 86 is one or greater, the rotation speed of the ring gear 92 is greater than the rotation speed of the carrier 98 in a state in which the sun gear 90 is not rotated. The second motor 52 is connected to the carrier 98. Thus, as compared to a structure in which the second motor 52 is connected to a ring gear to transmit torque, increases in the rotation speed of the second motor 52 are limited during the application of assist power. This contributes to reduction in the power consumption of the second motor 52.

The present invention is not limited to the above embodiments. For example, the embodiments can be modified as follows. The power switching mechanism 48 of the first embodiment can be located between the crankshaft 42 and the carrier 62. In this case, a groove having different depths in the circumferential direction is formed in one of the outer circumference of the crankshaft 42 and the inner circumference of the carrier 62, and rolling elements are located in the groove. In a case in which the crankshaft 42 is rotated in the reverse rotation direction, the power switching mechanism 48 integrally rotates the crankshaft 42 and the carrier 62 and also integrally rotates the ring gear 56 and the carrier 62.

In the first embodiment, a groove having different depth in the circumferential direction can be formed in the outer circumference of the carrier 62 at a portion opposing the ring gear 56. The rolling elements 66 are located in the groove. In this case, the groove 56B can be omitted from the ring gear 56.

In the first embodiment, the groove 56B of the ring gear 56 can be changed to a groove that is deep at the reverse rotation side end and shallows toward the forward rotation side end. In a state in which the rolling elements 66 are located at the reverse rotation side end of the groove 56B, the ring gear 56 and the carrier 62 are relatively rotatable. In this case, a one-way clutch can be located between the sun gear 54 or the rotor 50B and the housing 44. The one-way clutch restricts rotation of the sun gear 54 relative to the housing 44 in a state in which the supply of power to the first motor 50 is stopped. Additionally, a one-way clutch can be located between the crankshaft 42 and the carrier 62. The one-way clutch restricts rotation of the crankshaft 42 relative to the carrier 62 in a state in which the supply of power to the first motor 50 is stopped.

The power switching mechanism 48 of the first embodiment can be changed to a pawl-type power switching mechanism. The power switching mechanism 48 can have any structure as long as the ring gear 56 and the carrier 62 are unconnected in a case in which the crankshaft 42 inputs rotation in the forward rotation direction, and the carrier 62 and the ring gear 56 are integrally rotated in the reverse rotation direction in a case in which the crankshaft 42 inputs rotation in the reverse rotation direction.

The one-way clutch 102 of the second embodiment can be located between the rotor 50B and the support portion 84A. Alternatively, the one-way clutch 102 can be located between the rotor 50B and the housing 84 at a portion other than the support portion 84A.

The one-way clutch 102 can be omitted from the second embodiment. In this case, to restrict rotation of the sun gear 90 relative to the housing 84, the rotation phase of the sun gear 90 is maintained relative to the housing 84 by performing control that prohibits rotation of the first motor 50.

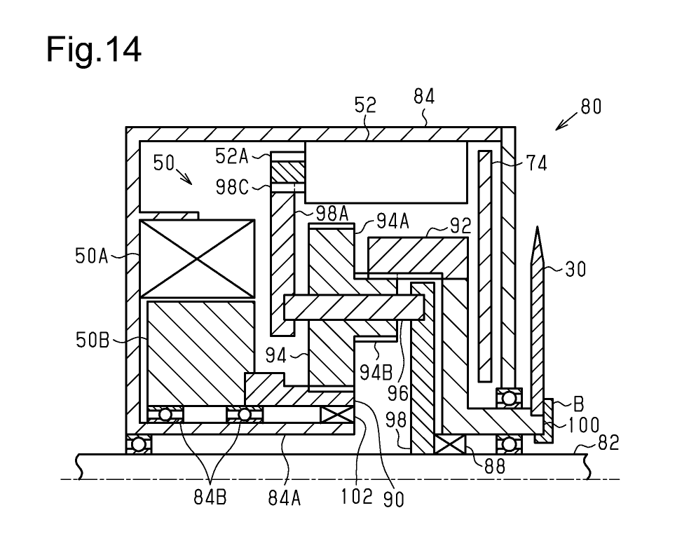

As shown in FIG. 14, the power switching mechanism 88 of the second embodiment can be located between the crankshaft 82 and the output portion 100. In this case, the second grooves are formed in the output portion 100, and the switching portion 104 is located at a portion where the inner circumference of the output portion 100 and the outer circumference of the crankshaft 82 are opposed.

In each embodiment, the controller 74 can drive the first motor 50 in the forward rotation direction. In this case, in the first embodiment, the groove 56B of the ring gear 56 is changed to a groove that is deep at the reverse rotation side end and shallows toward the forward rotation side end. The one-way clutch 102 is omitted from the second embodiment. In a state in which the first motor 50 rotates the sun gear 54 in the forward rotation direction, the gear ratio GR is decreased.

In the embodiments, the first motor 50 can be located at a radially outer side of the crankshafts 42, 82. In this case, stepped gears that are arranged coaxially with the crankshafts 42, 82 are used as the sun gears 54, 90, respectively.

In each embodiment, the first motor 50 can be changed to a motor of an outer rotor type in which the rotor 50B extends around the stator 50A.

In the embodiments, each of the sun gears 54, 90 and the output shaft of the first motor 50 can be separately formed. Each of the sun gears 54, 90 can be connected to the output shaft of the first motor 50 by spline fitting or the like.

In each embodiment, the second motor 52 can be coaxially arranged around the corresponding one of the crankshafts 42, 82.

The second motor 52 can be omitted from each embodiment.

The second motor 52 of the first embodiment can be connected to the ring gear 56. Also, the second motor 52 of the second embodiment can be connected to the carrier 98. In other words, the second motor 52 can be connected to any one of the input body and the output body of the planetary gear mechanisms 46, 86.

In the embodiments, the crankshafts 42, 82 can be omitted from the drive units 40, 80. Crankshafts formed separately from the drive units 40, 80 can be coupled to the drive units 40, 80.

In the embodiment, at least one of the first motor 50 and the second motor 52 can be located outside the housings 44, 84.

In the embodiments, a reduction mechanism can be located respectively between the crankshafts 42, 82 and the carriers 62, 98 or between each of the ring gears 56, 92 and the front sprocket 30. The reduction mechanism can be realized by at least two gears or a planetary gear mechanism.

In the embodiments, each of the planetary gear mechanisms 46, 86 can be changed to a planetary gear mechanism in which the input body is the carrier, the output body is the sun gear, and the transmission body is the ring gear.

In the embodiments, each of the planetary gear mechanisms 46, 86 can be changed to a planetary gear mechanism in which the input body is the sun gear, the output body is the carrier, and the transmission body is the ring gear.

In the embodiments, each of the planetary gear mechanisms 46, 86 can be changed to a planetary gear mechanism in which the input body is the ring gear, the output body is the sun gear, and the transmission body is the carrier. In this planetary gear mechanism, the ring gear and the sun gear rotate in different directions. Thus, the planetary gear mechanism includes a transmission gear located between the sun gear and the front sprocket 30 to change the rotation direction.

In the embodiments, each of the planetary gear mechanisms 46, 86 can be changed to a planetary gear mechanism in which the input body is the sun gear, the output body is the ring gear, and the transmission body is the carrier. In this planetary gear mechanism, the sun gear and the ring gear rotate in different directions. Thus, the planetary gear mechanism includes a transmission gear located between the ring gear and the front sprocket 30 to change the rotation direction.

In the embodiments, the crankshafts 42, 82, the sun gears 54, 90, the carriers 62, 98, and the ring gears 56, 92 can each be formed separately as long as the crankshafts 42, 82, the sun gears 54, 90, the carriers 62, 98, and the ring gears 56, 92 are coupled to one another and integrally rotated. For example, in the first embodiment, the coupling portion 62C and the first carrier 62A can be separately formed. The coupling portion 62C and the first carrier 62A are connected by spline fitting or press fitting and integrally rotated. Also, in the second embodiment, the portion of the ring gear 92 including the second grooves 92A and the outer circumferential portion of the ring gear 92 can be separately formed and connected by spline fitting or press fitting so as to be integrally rotatable.

Typically, the rotation direction (forward rotation direction) of the crankshaft that moves the bicycle 10 forward is referred to as the first rotation direction. The reverse rotation direction is referred to as the second rotation direction. However, the first rotation direction and the second rotation direction can refer to the opposite directions.

The embodiments and modified examples can be combined or replaced with one another. The advantages of such combinations and replacements should be apparent to those skilled in the art from the disclosure of the specification and drawings of the present application. The present invention is not limited to the exemplified examples. For example, the exemplified features should not be understood as being essential to the present invention, and the subject matter of the present invention may exist in fewer features than all features of a certain one of the disclosed embodiments.

1. A bicycle drive unit comprising:
a planetary gear mechanism;
a first motor; and
a power switching mechanism,
the planetary gear mechanism including an input body configured to receive a rotational input of a crankshaft, an output body configured to externally output rotation of the planetary gear mechanism, and a transmission body,
the first motor being configured to control rotation of the transmission body,
in a case in which the crankshaft inputs rotation to the input body in a first rotation direction, the output body is rotated in a direction corresponding to the first rotation direction, and
in a case in which the crankshaft inputs rotation to the input body in a second rotation direction, the power switching mechanism rotates the output body in a direction corresponding to the second rotation direction.

2. The bicycle drive unit according to claim 1, wherein
in a case in which the crankshaft inputs rotation to the input body in the second rotation direction, the power switching mechanism connects the input body and the output body to integrally rotate the input body and the output body.

3. The bicycle drive unit according to claim 1, wherein
the input body is a ring gear,
the output body is a carrier, and
the transmission body is a sun gear.

4. The bicycle drive unit according to claim 3, wherein
in a case in which the crankshaft inputs rotation to the ring gear in the first rotation direction and the carrier is rotated faster than the ring gear, the power switching mechanism allows for relative rotation of the ring gear and the carrier.

5. The bicycle drive unit according to claim 3, wherein
in a case in which the crankshaft inputs rotation to the ring gear in the first rotation direction, the power switching mechanism connects the ring gear and the carrier to integrally rotate the ring gear and the carrier until the carrier is rotated faster than the ring gear.

6. The bicycle drive unit according to claim 3, wherein
the power switching mechanism is east partially located between the ring gear or the crankshaft and the carrier.

7. The bicycle drive unit according to claim 3, wherein
the ring gear and the carrier include a portion where an inner circumference of the ring gear and an outer circumference of the carrier are opposed in a radial direction of the planetary gear mechanism, and
the power switching mechanism is located at the portion where the inner circumference of the ring gear and the outer circumference of the carrier are opposed.

8. The bicycle drive unit according to claim 7, wherein
the power switching mechanism includes
a groove formed in one of the inner circumference of the ring gear and the outer circumference of the carrier, the groove has different depths in a circumferential direction, and
a rolling element located in the groove.

9. The bicycle drive unit according to claim 8, wherein the groove shallows from an intermediate portion toward two opposite ends in the circumferential direction.

10. The bicycle drive unit according to claim 9, wherein
the power switching mechanism further includes a first biasing member, a second biasing member, and a housing in which the planetary gear mechanism is located,
the first biasing member applies force that is directed toward one end of the groove to the rolling element, and
the second biasing member is supported by the housing in a slidable manner,
in a case in which the crankshaft inputs rotation to the input body in the second rotation direction, the second biasing member applies force that is directed toward another end of the groove to the rolling element.

11. The bicycle drive unit according to claim 1, wherein
the input body is a carrier,
the output body is a ring gear, and
the transmission body is a sun gear.

12. The bicycle drive unit according to claim 11, wherein
the power switching mechanism is at least partially located between the ring gear and the carrier or the crankshaft.

13. The bicycle drive unit according to claim 12, wherein
the crankshaft and the ring gear include a portion where an outer circumference of the crankshaft and an inner circumference of the ring gear are opposed in a radial direction of the planetary gear mechanism, and
the power switching mechanism is located at the portion where the inner circumference of the ring gear and the outer circumference of the crankshaft are opposed.

14. The bicycle drive unit according to claim 13, wherein
the power switching mechanism includes a switching portion located at the portion where the outer circumference of the crankshaft and the inner circumference of the ring gear are opposed,
the switching portion includes
a rotation shaft that is coupled to the carrier and parallel to an axial direction of the carrier, and
a pawl that is rotatably supported by the rotation shaft,
in the switching portion, in a case in which the crankshaft is rotated in the first rotation direction, the pawl is separated from at least one of the crankshaft and the ring gear, and
in a case in which the crankshaft is rotated in the second rotation direction, the pawl is rotated about the rotation shaft, thereby bringing the pawl into contact with the crankshaft and the ring gear and connecting the carrier and the ring gear.

15. The bicycle drive unit according to claim 14, wherein
the power switching mechanism further includes
a projection formed on one of the outer circumference of the crankshaft and the inner circumference of the carrier at the portion where the outer circumference of the crankshaft and the inner circumference of the carrier are opposed,
a first groove formed in the other one of the outer circumference of the crankshaft and the inner circumference of the carrier at the portion where the outer circumference of the crankshaft and the inner circumference of the carrier are opposed, the first groove receives the projection so that the carrier is movable relative to the ring gear,
a second groove formed in the inner circumference of the ring gear at a portion opposing the outer circumference of the crankshaft, and
a biasing member that applies force to the pawl,
the biasing member applies force that pushes the pawl against the outer circumference of the crankshaft,
in a case in which the crankshaft is rotated in the first rotation direction, movement of the crankshaft relative to the carrier in the first rotation direction rotates and removes the pawl from the second groove of the ring gear to separate the pawl from the ring gear, and
in a case in which the crankshaft is rotated in the second rotation direction, movement of the crankshaft relative to the carrier in the second rotation direction rotates the pawl into the second groove of the ring gear to fit the pawl into the second groove of the ring gear, thereby connecting the carrier and the ring gear.

16. The bicycle drive unit according to claim 11, further comprising:
a housing that accommodates at least the planetary gear mechanism; and
a one-way clutch located between the sun gear and the housing, the one-way clutch allowing the sun gear to rotate relative to the housing only in a single rotation direction.

17. The bicycle drive unit according to claim 11, further comprising:
a housing that accommodates at least the planetary gear mechanism; and
a one-way clutch located between an output shaft of the first motor or a rotor of the first motor and the housing, the one-way clutch allowing the output shaft of the first motor or the rotor of the first motor to rotate relative to the housing in a single rotation direction.

18. The bicycle drive unit according to claim 3, wherein
the sun gear is arranged around the crankshaft to be coaxially with the crankshaft.

19. The bicycle drive unit according to claim 2, wherein
the first motor is arranged around the crankshaft to be coaxially with the crankshaft.

20. The bicycle drive unit according to claim 19, wherein
the input body is a ring gear,
the output body is a carrier,
the transmission body is a sun gear that is arranged around the crankshaft to be coaxially with the crankshaft, and
the sun gear is integrally formed with an output shaft of the first motor.

21. The bicycle drive unit according to claim 1, further comprising:
an output portion connected to the output body, a front sprocket being attachable to the output portion.

22. The bicycle drive unit according to claim 1, further comprising:
the crankshaft.

23. The bicycle drive unit according to claim 1, further comprising:
a second motor that transmits torque to the output body or the input body.

24. The bicycle drive unit according to claim 23, wherein
the second motor includes a rotation shaft, and
the rotation shaft of the second motor is separated from the crankshaft in a radial direction of the crankshaft.

25. The bicycle drive unit according to claim 23, further comprising:
a controller that controls the first motor and the second motor.
